(19) United States
(12) Patent Application Publication
(10) Pub. No.: US 2024/0428455 A1
(43) Pub. Date: Dec. 26, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: KAZUFUMI ONUMA, Kanagawa (JP)

(21) Appl. No.: 18/749,402

(22) Filed: Jun. 20, 2024

(30) Foreign Application Priority Data
Jun. 23, 2023 (JP) 2023-103415

(51) Int. Cl. G06T 7/73; G06T 7/246; G06V 10/764; G06V 40/10

(52) U.S. Cl. CPC G06T 7/75; G06T 7/251; G06V 10/764; G06V 40/10; G06T 2207/20101; G06T 2207/30196; G06T 2207/30221

(57) ABSTRACT

An information processing apparatus includes an acquisition unit configured to acquire position information indicating a position of an object included in an image capturing area captured by a plurality of image capturing apparatuses, a specification unit configured to specify one position of interest from among a plurality of positions of interest, based on a moving direction of the object, and a determination unit configured to determine a position of a virtual viewpoint corresponding to a virtual viewpoint image related to the object and a line-of-sight direction of the virtual viewpoint, based on the specified position of interest and the position of the object.

### BACKGROUND

### Field

The present disclosure relates to an image processing apparatus for generating a virtual viewpoint image.

### Description of the Related Art

A technique for generating an image (virtual viewpoint image) from a freely selected virtual viewpoint (virtual camera) based on a user operation by using a plurality of images obtained through synchronous image capturing executed by a plurality of cameras installed in different locations attracts public attention. This technique allows a viewer to view highlight scenes of sporting events, such as soccer and basketball, from various angles, so that the viewer can experience a high sense of realism as compared with a normal image.

In order to allow a user to easily operate the virtual viewpoint, Japanese Patent Application Laid-Open No. 2022-171436 discusses a method for determining a position and orientation of the virtual viewpoint based on position information about a first object of attention and position information about a second object that is to be included in a virtual viewpoint image together with the first object.

### SUMMARY

According to an aspect of the present disclosure, an information processing apparatus includes an acquisition unit configured to acquire position information indicating a position of an object included in an image capturing area captured by a plurality of image capturing apparatuses, a specification unit configured to specify one position of interest from among a plurality of positions of interest, based on a moving direction of the object, and a determination unit configured to determine a position of a virtual viewpoint corresponding to a virtual viewpoint image related to the object and a line-of-sight direction of the virtual viewpoint, based on the specified position of interest and the position of the object.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an image processing system according to one or more aspects of the present disclosure.

FIGS. 2A to 2E are diagrams illustrating object position tracking processing according to one or more aspects of the present disclosure.

FIGS. 3A and 3B are diagrams illustrating processing of applying an identifier to an object position according to one or more aspects of the present disclosure.

FIG. 4 is a diagram illustrating an example of a representative position of an object according to one or more aspects of the present disclosure.

FIG. 5 is a flowchart illustrating object position tracking processing to be executed by a tracking unit according to one or more aspects of the present disclosure.

FIG. 6 is a flowchart illustrating object-of-interest determination processing to be executed by an object-of-interest determination unit according to one or more aspects of the present disclosure.

FIGS. 7A and 7B are diagrams illustrating examples of a velocity vector of each object and an average velocity vector according to one or more aspects of the present disclosure.

FIG. 8 is a diagram illustrating an example of a position of a virtual viewpoint generated by a viewpoint generation unit according to one or more aspects of the present disclosure.

FIG. 9 is a flowchart illustrating object-of-interest determination processing to be executed by an object-of-interest determination unit according to one or more aspects of the present disclosure.

FIG. 10 is a diagram illustrating examples of objects of interest and determination areas according to one or more aspects of the present disclosure t.

FIGS. 11A to 11C are diagrams illustrating examples of an object, objects of interest, a virtual viewpoint, and respective movements thereof according to one or more aspects of the present disclosure.

FIG. 12 is a block diagram illustrating an example of a hardware configuration of an information processing apparatus.

### DESCRIPTION OF THE EMBODIMENTS

### (System Configuration and Operation of Image Processing Apparatus)

A first exemplary embodiment of the present disclosure will be described. An image processing system is a system that generates a virtual viewpoint image representing a view from a specified virtual viewpoint based on a plurality of images captured by a plurality of image capturing apparatuses and the specified virtual viewpoint. While virtual viewpoint images in the present exemplary embodiment are free viewpoint videos, a virtual viewpoint image is not limited to an image corresponding to a viewpoint freely (optionally) specified by a user, and an image corresponding to a viewpoint that the user has selected from a plurality of candidates is also included in the virtual viewpoint image. The present exemplary embodiment is mainly described with respect to a case where the virtual viewpoint image is a moving image. However, the virtual viewpoint image can be a still image.

Viewpoint information that is used for generating a virtual viewpoint image is information indicating a position and orientation (line-of-sight direction) of a virtual viewpoint. Specifically, the viewpoint information is a set of parameters including parameters indicating a three-dimensional position of the virtual viewpoint and parameters indicating an orientation of the virtual viewpoint in the pan, tilt, and roll directions. Further, the viewpoint information are not limited to the above. For example, a set of parameters provided as the viewpoint information may include a parameter indicating a magnitude of a field of view (i.e., angle of view) at the virtual viewpoint. The viewpoint information may include a plurality of sets of parameters. For example, the viewpoint information may include a plurality of sets of parameters, each corresponding to a plurality of frames of a virtual viewpoint moving image, and may indicate the position and orientation of the virtual viewpoint at each consecutive time.

The image processing system includes a plurality of image capturing apparatuses for capturing an image capturing area in a plurality of directions. For example, the image capturing area is an athletic field where sporting events, such as soccer and karate, are taken place, or a stage where a concert and a theatrical play are performed. The plurality of image capturing apparatuses is installed at different positions to surround such an image capturing area, and performs image capturing in a synchronized manner. The plurality of image capturing apparatuses does not always have to be installed in the entire circumference of the image capturing area, and may be installed in only a part of the circumference thereof depending on a condition such as limitation in the installation site. Further, the number of image capturing apparatuses is not limited to the example illustrated in the drawings. In a case where the image capturing area is a soccer stadium, for example, approximately thirty image capturing apparatuses may be installed in the periphery of the stadium. Furthermore, image capturing apparatuses having different functions, such as telephotographic cameras and wide-angle cameras, may be installed.

It is assumed that each of the image capturing apparatuses according to the present exemplary embodiment is a camera having an independent body, capable of capturing images with an individual viewpoint. However, the image capturing apparatuses are not limited thereto, and two or more image capturing apparatuses may be arranged in one body. For example, a single camera having a plurality of lens groups and sensors, capable of capturing images from a plurality of viewpoints, may be installed as the plurality of image capturing apparatuses.

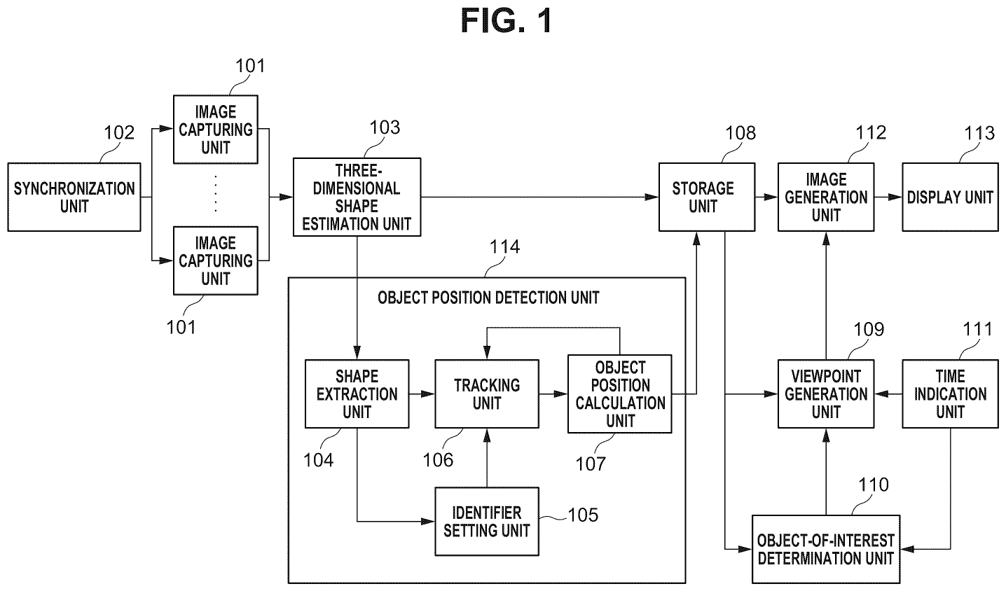

FIG. 1 is a block diagram illustrating a configuration of the image processing system according to a first exemplary embodiment. For example, the image processing system includes image capturing units 101, a synchronization unit 102, a three-dimensional shape estimation unit 103, a shape extraction unit 104, an identifier setting unit 105, a tracking unit 106, an object position calculation unit 107, a storage unit 108, a viewpoint generation unit 109, an object-of-interest determination unit 110, and a time indication unit 111. The image processing system further includes an image generation unit 112 and a display unit 113. In the present exemplary embodiment, the shape extraction unit 104, the identifier setting unit 105, the tracking unit 106, and the object position calculation unit 107 are collectively called an object position detection unit 114. The image processing system may be a system including one image processing apparatus or a system including a plurality of image processing apparatuses.

For example, the viewpoint generation unit 109, the object-of-interest determination unit 110, the time indication unit 111, and the object position detection unit 114 may be included in one information processing apparatus different from the image processing apparatus, and the storage unit 108 may be configured with a dedicated server apparatus. Hereinafter, the image processing system is described as one image processing apparatus.

The image capturing units 101 perform image capturing in synchronization with each other based on a synchronization signal output from the synchronization unit 102.

The image capturing units 101 then output captured images to the three-dimensional shape estimation unit 103. In order to perform image capturing of an object from a plurality of directions, the image capturing units 101 are arranged to surround the image capturing area including the object.

The synchronization unit 102 outputs a synchronization signal to the plurality of image capturing units 101.

The three-dimensional shape estimation unit 103 generates a silhouette image of an object using images captured from a plurality of viewpoints, input thereto. The three-dimensional shape estimation unit 103 further generates a three-dimensional model (3D model) of the object through a method such as a volume intersection method. The three-dimensional shape estimation unit 103 then outputs the generated 3D model of the object and captured images to the storage unit 108 and the shape extraction unit 104. Herein, objects refer to physical bodies to serve as generation targets of 3D models, and include a person and an item used by the person.

The shape extraction unit 104 extracts a portion of a 3D model of an object acquired from the three-dimensional shape estimation unit 103. In a case where 3D models of a plurality of objects are present, a portion of the 3D model of the object is extracted, which reduces the possibility that objects cannot be identified from one another because the objects are in contact with each other or adjacent with each other. Further, the shape extraction unit 104 generates a two-dimensional image of the extracted 3D model of the object projected from one direction. In the present exemplary embodiment, a two-dimensional image projected from a direction vertical to a floor surface is generated. The shape extraction unit 104 extracts extraction information about the 3D model of the object from the generated two-dimensional image, and transmits the extraction information to the tracking unit 106 and the identifier setting unit 105.

The identifier setting unit 105 applies identifiers to the extraction information acquired from the shape extraction unit 104. The identifiers applied to the respective extracted shapes are transmitted to the tracking unit 106.

In response to an input of the identifiers from the identifier setting unit 105, the tracking unit 106 applies the identifiers to the respective extracted shapes as an initial state. Thereafter, the tracking unit 106 tracks the extracted shapes to which the identifiers are applied. The tracked extracted shapes tracked and the identifiers are transmitted to the object position calculation unit 107.

The object position calculation unit 107 calculates a representative position (object position) of each object using the extracted shapes and the identifiers acquired from the tracking unit 106. The representative position of the object resulting from the calculation is transmitted to the storage unit 108.

The storage unit 108 saves and stores the following data group as data (virtual viewpoint material data) to be used for generating a virtual viewpoint image. In the present exemplary embodiment, specifically, the data used for generating a virtual viewpoint image is captured images and a 3D model of the object that are input to the storage unit 108 from the three-dimensional shape estimation unit 103. The data to be used for generating a virtual viewpoint image includes camera parameters of positional attitudes and optical characteristics of the image capturing units 101 and object position information acquired by the object position detection unit 114. As the data used to be for generating a background of the virtual viewpoint image, 3D models of backgrounds and background texture images are previously saved (stored) in the storage unit 108. Further, a category is in association with the respective 3D models stored in the storage unit 108. Herein, each category is set for the corresponding image capturing target. For example, for baseball, the categories include a player, a ball, and a referee among other objects. The categories of the 3D models may be specified by a user, or may automatically be set depending on conditions previously set. The storage unit 108 stores object-of-interest candidates described below. The object-of-interest candidates may be a background model or specific three-dimensional coordinates (position of interest) in a three-dimensional space. While the present exemplary embodiment is described based on a premise that the user previously sets the object-of-interest candidates, the image processing system may automatically set the object-of-interest candidates. For example, an object-of-interest candidate automatically set by the apparatus may be a central position of an image capturing area of a plurality of image capturing locations, an object present in that central position, a position of a boundary area between the image capturing area and other areas, or an object present in that position. In the present exemplary embodiment, the object-of-interest candidate is a background model. For example, a basket goal, a soccer goal, and a goal line of track and field are background models.

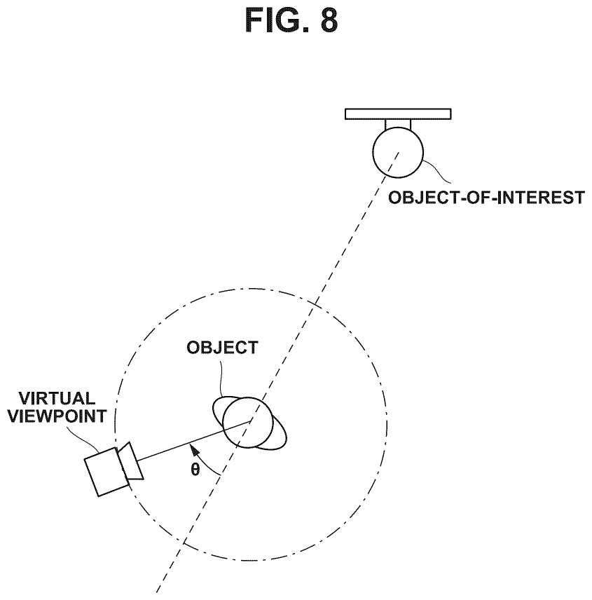

The viewpoint generation unit 109 generates a virtual viewpoint based on the object position information detected by the object position detection unit 114 and the position information about the object of interest output from the object-of-interest determination unit 110. Specifically, as illustrated in FIG. 8, the viewpoint generation unit 109 sets the position of a virtual viewpoint to a position away from the object by a predetermined distance in a direction with a predetermined rotation angle θ from a line that connects the object specified by the user and a barycentric position of the background model serving as the object of interest, with a position of the object as a center. The viewpoint generation unit 109 sets a line-of-sight direction and an angle of view from the virtual viewpoint so that the object and the background model are included in a field of view of the virtual viewpoint (virtual camera). The viewpoint generation unit 109 generates virtual viewpoint information indicating parameters, such as a position of the virtual viewpoint, a line-of-sight direction of the virtual viewpoint, and an angle of view of the virtual viewpoint, and outputs the virtual viewpoint information to the image generation unit 112. The position of the virtual camera may be set on the line that connects the position of the object specified by the user and the barycentric position of the background model serving as the object of interest. The rotation angle θ may be set by the user. Further, the viewpoint generation unit 109 includes a viewpoint operation unit serving as a physical user interface, such as a joystick or an operation button, and a display unit for displaying a virtual viewpoint image, which are not illustrated. The viewpoint operation unit enables the user to set parameters for generating the virtual viewpoint information, such as a distance between the object included in the virtual viewpoint image and the virtual viewpoint, an orientation of the virtual viewpoint, and a height of the virtual viewpoint. According to change of the parameters, the virtual viewpoint image is updated by the below-described image generation unit 112 at any time, and displayed on the display unit. The display unit 113 described below may also operate as the display unit, or other display apparatuses may be provided as the display unit. The virtual viewpoint information output from the viewpoint generation unit 109 includes information corresponding to external parameters of a camera, such as a position and orientation of a virtual viewpoint, information corresponding to internal parameters of a camera, such as a focal distance and an angle of view, and time information specifying the image capturing time to be reproduced.

The object-of-interest determination unit 110 determines one of a plurality of the previously set object-of-interest candidates to be an object of interest through the object-of-interest determination processing described below, and outputs the object of interest to the viewpoint generation unit 109.

The time indication unit 111 generates time information indicating the time corresponding to the virtual viewpoint image to be generated by the image generation unit 112 described below, and outputs the time information to the viewpoint generation unit 109 and the object-of-interest determination unit 110.

The time indication unit 111 includes at least any one of a graphical user interface (GUI) and user interfaces, such as physical user interfaces including, for example, a plurality of buttons and/or jog dials, so that time at which a video is generated can be changed by a user operation performed thereon.

The image generation unit 112 acquires, based on the time information included in the virtual viewpoint information input thereto, material data at the image capturing time from the storage unit 108. The image generation unit 112 generates a virtual viewpoint image at a set virtual viewpoint, using the 3D model of the object and the captured images included in the acquired material data.

The display unit 113 serves as a display unit for displaying a video received from the image generation unit 112. The display unit 113 includes a display, head-mounted display (HMD), or the like.

### (Tracking Method of Object Position)

Next, a method of tracking a three-dimensional position of an object according to the present exemplary embodiment is described.

The three-dimensional shape estimation unit 103 initially generates a 3D model of the object and outputs the generated 3D model to the storage unit 108 and the shape extraction unit 104.

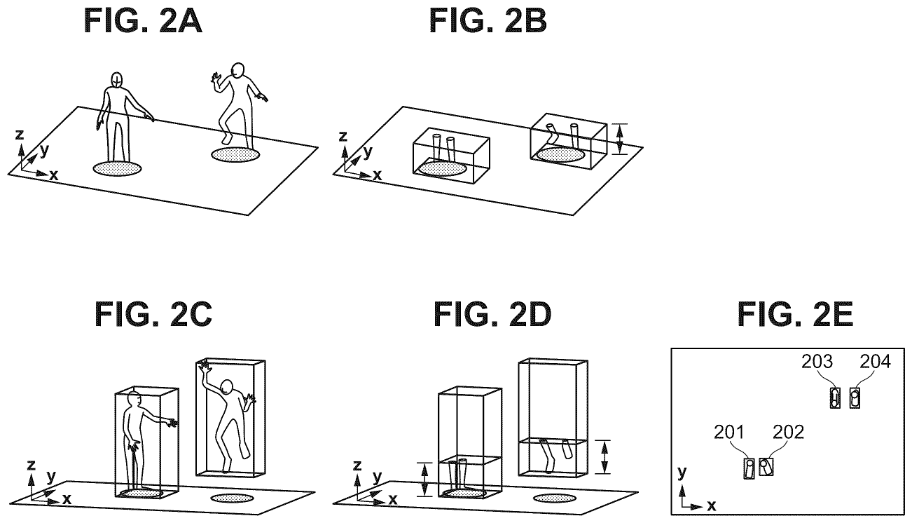

FIGS. 2A to 2E are diagrams illustrating processing of tracking an object position according to the present exemplary embodiment. As illustrated in FIG. 2B, the shape extraction unit 104 cuts out lower portions of 3D models of objects from the 3D models of the objects illustrated in FIG. 2A. In the present exemplary embodiment, the shape extraction unit 104 cuts out a portion having a predetermined height (e.g., a height corresponding to 50 cm) from the bottom of a circumscribed rectangular parallelepiped of the 3D model of the object. For example, as illustrated in FIG. 2C, in a case where one object is standing on a floor and another object is jumping and separating from a floor surface in an image capturing area, portions in ranges illustrated in FIG. 2D are cut out from the 3D models of the objects. In other words, any 3D model portion having a predetermined height from a portion corresponding to the feet is cut out from the corresponding 3D model of the object. The area to be cut out from the 3D model is not limited to the lower portion of the 3D model. For example, a middle portion of the 3D model of the object (e.g., an area of 50 cm to 100 cm from the bottom of the circumscribed rectangular parallelepiped of the 3D model) may be cut out.

Next, as illustrated in FIG. 2E, the shape extraction unit 104 projects the cut out portions of the 3D models on the floor surface to generate a two-dimensional image. In the present exemplary embodiment, the projected image is a binary image in which the cut out portions of the 3D models are illustrated in white, and the other portions are illustrated in black. The shape extraction unit 104 divides the two-dimensional image by an independent area to acquire circumscribed rectangular parallelepipeds 201 to 204 illustrated in FIG. 2E. The shape extraction unit 104 outputs vertex information about the circumscribed rectangular parallelepipeds 201 to 204 as the extracted shapes of the extracted portions of the 3D models. Specifically, the shape extraction unit 104 outputs the vertex information about the circumscribed rectangular parallelepipeds 201 to 204 after converting the vertex information into a coordinate system and a unit the same as those in the three-dimensional space of the image capturing area. The shape extraction unit 104 determines the independent shapes by executing processing using a method such as a continuous component analysis on the projected two-dimensional image. The use of the above-described method enables the shape extraction unit 104 to divide a 3D model into individual areas.

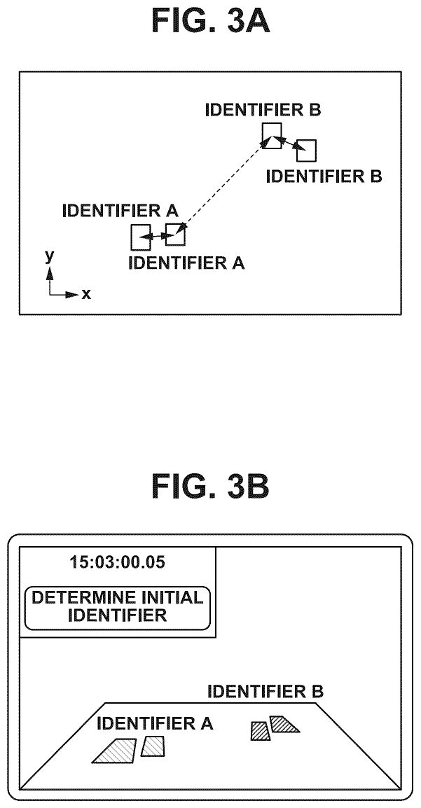

FIGS. 3A and 3B are diagrams illustrating the processing for applying an identifier to an object position according to the present exemplary embodiment. The identifier setting unit 105 applies identifiers to the extracted shapes output from the shape extraction unit 104. Specifically, the identifier setting unit 105 calculates a distance between the extracted shapes, and applies identifiers to the extracted shapes depending on a distance between the extracted shapes. For example, as illustrated in FIG. 3A, the identifier setting unit 105 allocates an identical identifier to the extracted shapes the distance between which is less than a predetermined distance (such a distance is indicated by a solid arrow), and allocates a different identifier to the extracted shapes the distance between which is greater than or equal to the predetermined distance (such a distance is indicated by a dashed arrow). It is desirable that a threshold of the predetermined distance to be used as a determination criterion is equivalent to a width between the feet of the object in a standing position. In the present exemplary embodiment, a threshold of the predetermined distance is set to 50 cm.

The identifier setting unit 105 displays the allocated identifiers on a display unit of the identifier setting unit 105 through a GUI as illustrated in FIG. 3B. The user operates the image processing system while looking at the GUI. Specifically, the identifier setting unit 105 displays, on the GUI, allocation of the current identifiers (i.e., identifiers in an initial state) in such a manner that the identifiers are differentiated with at least any one of characters and color-coding. In FIG. 3B, the identifier setting unit 105 displays the identifiers using both of the characters and color-coding. The user checks the GUI and checks whether the identifiers are desirably allocated in the initial state. In a case where the identifiers are not desirably allocated, the user repeatedly instructs the object to change a standing position and/or to reduce a width between the feet until a desired allocation is obtained. Alternatively, the user operates the image processing system via the GUI to input change instructions so that the identifiers are desirably allocated. In a case where the identifiers are desirably allocated, the user presses a determination button (initial identifier determination button) displayed on the GUI illustrated in FIG. 3B. In response to this operation, the identifier setting unit 105 determines the identifiers in the initial state. Further, a category of each object may be set to the identifier in the initial state. It is assumed that categories are individually set with respect to the image capturing targets (e.g., baseball and live performance). In the present exemplary embodiment, basketball is assumed to be the image capturing target, and any one of categories, namely a player, a referee, and a ball, is set to each object. Although it is assumed that the categories are input and set by the user, a method thereof is not limited thereto. For example, a condition for setting a category “a ball” to an object corresponding to an extracted shape present without presence of other extracted shapes within a predetermined distance in the initial state may be set previously, and the category is set concurrently with determination of the identifier. The identifier setting unit 105 outputs the information indicating the identifiers and the categories determined for each extracted shape to the tracking unit 106.

In response to the input of the identifiers from the identifier setting unit 105, the tracking unit 106 applies the identifiers to the extracted shapes as an initial state. After that, the tracking unit 106 tracks the extracted shapes to which the identifiers are applied. The identifier that is applied to an extracted shape during tracking is not the one determined by the identifier setting unit 105, but the one that is determined based on a result of tracking a position of the respective extracted shape performed by the tracking unit 106. The tracking unit 106 executes tracking of an extracted shape, based on the position of the extracted shape corresponding to the time immediately before the image capturing time of the extracted shape, the identifier of the extracted shape, and the information about the object position input by the object position calculation unit 107 described below. The tracking processing executed by the tracking unit 106 is specifically described below.

The tracking unit 106 applies, based on a tracking result, identifiers to respective extracted shapes at corresponding time, and outputs the extracted shapes to the object position calculation unit 107.

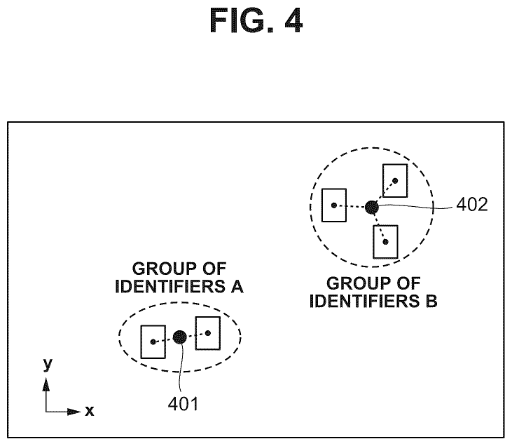

FIG. 4 is a diagram illustrating a representative position of the object according to the present exemplary embodiment. The object position calculation unit 107 determines a representative position of the extracted shapes to which the identifier is applied, acquired from the tracking unit 106. For example, as illustrated in FIG. 4, the object position calculation unit 107 determines the positions, such as a representative position 401 and a representative position 402, each of which indicates a group of extracted shapes, for each group of extracted shapes to which the identical identifier is applied. In the present exemplary embodiment, the representative position is a central position of a group of extracted shapes.

However, the representative position is affected by a shape estimation error or a fluctuation of a boundary portion resulting from cutout of a shape with the shape extraction unit 104, so that the position may be fluctuated at respective time even if the object remains still. Therefore, the object position calculation unit 107 performs processing such as low-pass filter processing and/or moving average processing in a temporal direction on the information about a central position corresponding to each time to generate position information with reduced high-frequency components, in the present exemplary embodiment. The object position calculation unit 107 outputs the position information about the representative position as the position information about the object together with the identifier. The object position calculation unit 107 further records (stores) the position information about the representative position and the information about the image capturing time of the object applied to the position information in the storage unit 108 as the position information about the object (object position information).

### (Tracking Processing Executed by Tracking Unit 106)

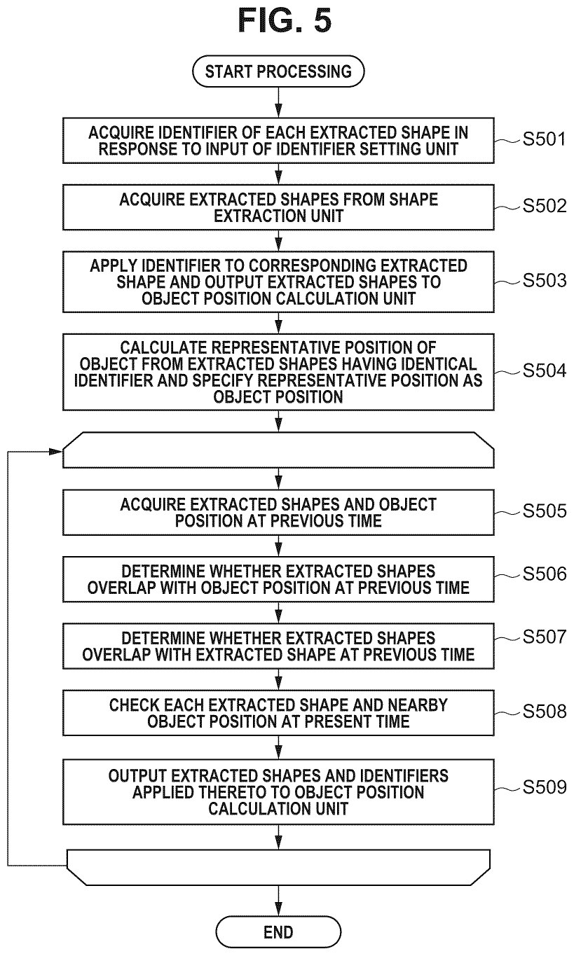

FIG. 5 is a flowchart illustrating the object position tracking processing to be executed by the tracking unit 106 according to the present exemplary embodiment.

In step S501, in response to the input from the identifier setting unit 105, the tracking unit 106 acquires an identifier and a category of each extracted shape.

In step S502, the tracking unit 106 acquires the extracted shapes input by the shape extraction unit 104.

In step S503, the tracking unit 106 applies the identifiers and the categories acquired from the identifier setting unit 105 to the acquired extracted shapes, and outputs, to the object position calculation unit 107, the extracted shapes to each of which the corresponding identifier and category are applied.

In step S504, the object position calculation unit 107 determines the object position from a group of the extracted shapes having the identical identifier, and outputs the object position to the tracking unit 106.

The above-described operations in steps S501 to S504 corresponds to the initialization processing.

The following operations in steps S505 to S509 are executed every time, and the processing is repeatedly executed while the image capturing units 101 are performing image capturing of the object. In a case where image capturing processing for the object executed by the image capturing units 101 is ended, the processing of this flowchart is ended when the processing in step S509 is completed.

In step S505, the tracking unit 106 acquires the extracted shapes input from the shape extraction unit 104 and the object position at time one time before (i.e., previous time) calculated by the object position calculation unit 107. For example, “time one time before” refers to the image capturing time of the respective extracted shapes generated one frame before the frame of the extracted shapes currently being processed. Herein, for the purpose of comparison, current time is also described as present time. The current time refers to the image capturing time of the image that is used for generating the extracted shapes currently being processed. Moreover, in step S505, the tracking unit 106 acquires a single extracted shape to which no identifier has been applied from among a plurality of extracted shapes extracted by the shape extraction unit 104. This operation is however not restrictive. Alternatively, in step S505, the tracking unit 106 may acquire all the extracted shapes extracted by the shape extraction unit 104. In such a case, operations in steps S506 to S509 are repeated as a repeat process for assignment of identifiers to respective extracted shapes, which will be described below.

In step S506, in a case where the object position at the previous time overlaps with the representative position of the extracted shapes at the present time, the tracking unit 106 applies the identifier applied to the object position overlapping with the representative position to the extracted shapes. In step S506, in a case where the representative position of one of the extracted shapes overlaps with a plurality of object positions, the tracking unit 106 applies an identifier indicating “non-determinable” to the corresponding extracted shape at the present time. This is because there is a possibility that a plurality of the extracted shapes with different identifiers applied overlap one another at the present time, as in a case where two objects come close to each other. Thus, in the operation in step S506, the tracking unit 106 applies the identifier indicating “non-determinable”. The processing in step S509 described below is executed on the extracted shapes having the identifiers including the identifier indicating “non-determinable”.

In step S507, in a case where the representative position of the extracted shapes to which no identifier has been applied overlaps with an extracted shape at the previous time, the tracking unit 106 applies the identifier that is applied to the extracted shape at the previous time to the corresponding extracted shape at the present time.

In step S508, in a case where another extracted shape with an identifier applied at the present time is present within a predetermined range from the extracted shape to which no identifier has been applied, the tracking unit 106 applies the identifier that is applied to the other extracted shape to the corresponding extracted shape. It is desirable that the predetermined range is equivalent to a width between the feet of the object in a standing position. For example, the predetermined range falls within a radius of 50 cm from the center of the extracted shape. In a case where other extracted shapes with identifiers applied are present within a predetermined range from a certain extracted shape, the tracking unit 106 applies the identifier of one of the extracted shapes, closest to the one extracted shape, to the certain extracted shape. For extracted shapes to which the identifier has not been applied at the stage where the processing in step S508 is completed, the tracking unit 106 determines that such extracted shapes are non-tracking targets. In this case, the tracking unit 106 does not output the extracted shapes determined to be the non-tracking targets to the object position calculation unit 107.

In step S509, the tracking unit 106 outputs the extracted shapes to which the identifiers are applied through the operations in steps S506 to S508 and the identifiers applied to those extracted shapes to the object position calculation unit 107.

After the operation in step S509 is completed, a control unit (not illustrated) determines whether identifiers have been assigned to all the extracted shapes extracted by the shape extraction unit 104. In a case where the control unit determines that identifiers have been assigned to not all the extracted shapes, the operation in step S505 is executed. In a case where the control unit determines that identifiers have been assigned to all the extracted shapes, the processing of this flowchart is ended.

The operations in steps S505 to S509 are executed on each extracted shape. The operations in steps S505 to S509 are repeated so that the identifiers set by the identifier setting unit 105 are associated with the extracted shapes in the frames corresponding to respective times.

The object position calculation unit 107 can distinctively acquire the object position for each object using the identifiers.

In a case where the tracking unit 106 applies the identifier indicating “non-determinable” to an extracted shape, there is a possibility that some of the identifiers set at the initial setting are not applied at certain time. In this case, the object position calculation unit 107 does not update the position information about the object having the identifier identical to the identifier not applied to any extracted shape. In this way, even if extracted shapes are overlapped due to, for example, a plurality of objects having approached, position information about the plurality of objects does not indicate the same position. In this case, positions of the plurality of objects at and before the previous time are each maintained as the object positions. Thereafter, in a case where the objects move apart and the plurality of overlapped extracted shapes are separated again, an identifier is allocated to each of the extracted shapes based on the most recent object position. In other words, update of the position information about the respective objects is started again in response to the overlap of the extracted shapes being dissolved.

Through the above-described processing, the image processing system can track each object and acquire the position information about each object even in a case where a plurality of objects is present in the image capturing area. Further, through the above-described processing, the image processing system can track each object irrespective of the occurrence of overlap or separation of generated 3D models due to, for example, objects coming close or moving apart from each other.

### (Object-of-Interest Determination Processing)

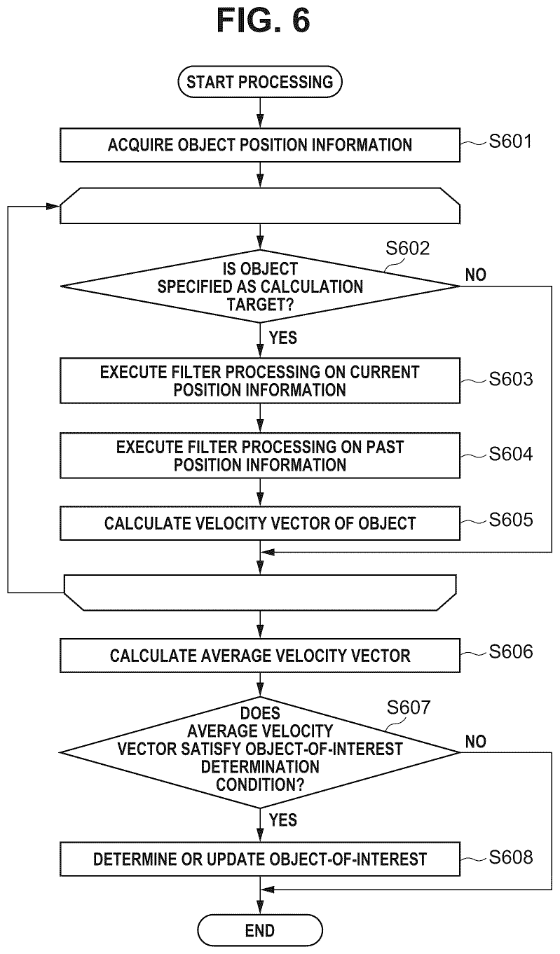

FIG. 6 is a flowchart illustrating the object-of-interest determination processing to be executed by the object-of-interest determination unit 110 according to the present exemplary embodiment. In the present exemplary embodiment, a description will be provided of an example in which an object of interest is determined when a virtual viewpoint image regarding basketball is generated. At this time, basket goals in both teams are set to object-of-interest candidates, and position information about the object-of-interest candidates is previously acquired from the storage unit 108. This processing is executed for each frame.

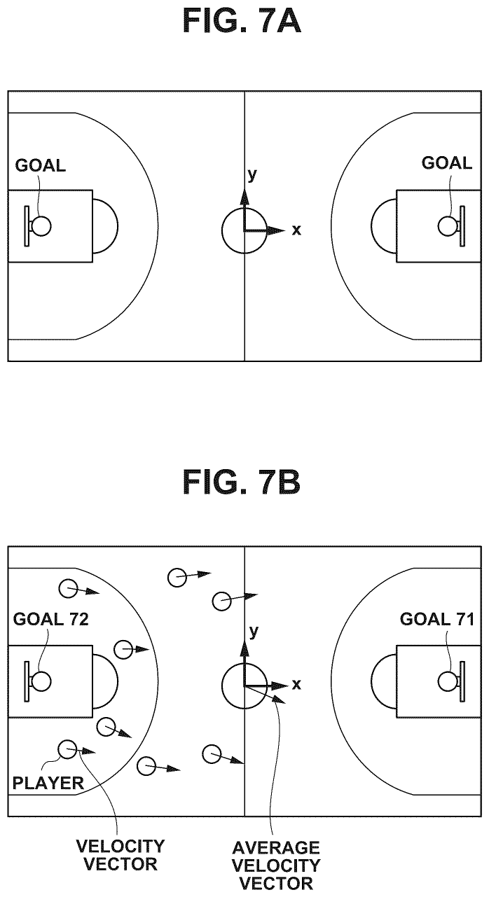

FIGS. 7A and 7B are diagrams illustrating velocity vectors and an average velocity vector of objects according to the present exemplary embodiment. Coordinate axes x and y are specified as illustrated in FIG. 7A, and a center of a court is specified as an origin (0, 0), where basket goals are located on the x axis.

In step S601, the object-of-interest determination unit 110 acquires, based on the time indicated by the time indication unit 111, object position information from the object position information that the object position detection unit 114 has detected and stored in the storage unit 108. At this time, the object-of-interest determination unit 110 acquires not only the object position information at the specified time but also the object position information for several frames to several tens of frames before and after that specified time. The following operations in steps S602 to S605 are executed with respect to each of the objects.

In step S602, the object-of-interest determination unit 110 determines whether an object is to be subjected to a calculation (such an object is referred to as calculation target). Specifically, the object-of-interest determination unit 110 determines whether to execute the subsequent processes based on whether a category corresponding to the identifier for identifying the object included in the position information matches calculation target information. The calculation target information specifies a calculation target of the object-of-interest determination processing. More specifically, the calculation target information specifies a category corresponding to the identifier of the object. For example, calculation target information is generated that specifies, as a calculation target, an object with the category corresponding to the identifier set to “player”, and the generated information is previously recorded in the storage unit 108 or the object-of-interest determination unit 110. In such a case, objects with the category set to “referee” or “ball” are eliminated from the calculation targets, so that the object-of-interest determination processing is not performed on those objects.

In step S603, filter processing is performed on pieces of position information about the object(s) determined to be the calculation target. Specifically, averaged position information is calculated by averaging the pieces of position information corresponding to a plurality of frames acquired in step S601. This process reduces deviation due to a detection error of the object position detection unit 114.

In step S604, the object-of-interest determination unit 110 acquires the object position information at past time, for example, one second before the time corresponding to the frame including the object serving as a calculation target, and the object position information corresponding to several frames to several tens of frames (predetermined time) before and after that time, and calculates the average value of the pieces of object position information.

In step S605, the averaged position information corresponding to the past time is subtracted from the averaged position information corresponding to the time of the frame including the object serving as the calculation target (hereinafter, such a time referred to as “time corresponding to the under-process frame), and then a difference between the pieces of positional information is divided by a temporal difference between the time corresponding to the under-process frame and the past time, which is one second, thus determining positional deviation (positional change) in unit time at the time corresponding to the under-process frame. A magnitude of this positional deviation in unit time represents a moving velocity, and an orientation of the vector on a two-dimensional plane represents a moving direction of an object. The foregoing operations in steps S602 to S605 are executed on each object. In a case where the processing is completed on all of the objects, the processing proceeds to step S606.

In step S606, an average velocity vector of the acquired velocity vectors of all of calculation target objects is calculated. FIG. 7B illustrates the calculated average velocity vector of all of calculation target objects. In the present exemplary embodiment, components of a goal direction included in the average velocity vector are determined. Specifically, a direction of the goal is positive and negative directions of the x axis, so that an orientation and magnitude of a vector acquired by orthographically projecting the average velocity vector on a vector of (1, 0) are acquired.

In step S607, it is determined whether the average velocity vector calculated in step S606 satisfies an object-of-interest determination condition. It is assumed that the object-of-interest determination condition varies depending on the image capturing target.

In the present exemplary embodiment, it is determined whether a vector acquired by projecting the average velocity vector on the goal direction satisfies the object-of-interest determination condition. In the initial state, where the object of interest has not been determined, the processing proceeds to step S608 irrespective of whether the object-of-interest determination condition is satisfied. In the present exemplary embodiment, the object-of-interest determination condition is that whether the orientation of the vector acquired by projecting the average velocity vector in the goal direction points the current object of interest, and that whether the magnitude of the vector is greater than a predetermined magnitude. In a case where the current object of interest has been determined, it is determined whether to change the object of interest based on the orientation and magnitude of the orthographically projected vector. In a case where the orthographically projected vector points in the positive direction and a magnitude thereof is greater than or equal to the predetermined magnitude, and the current object of interest is not a goal 71 located on the positive side of the x axis, the processing proceeds to step S608.

In a case where the orthographically projected vector points in the negative direction and a magnitude thereof is greater than or equal to the predetermined magnitude, and the current object of interest is not a goal 72 located on the negative side of the x axis, the processing proceeds to step S608. In a case where the vector does not satisfy any of the above-described conditions, the object-of-interest determination processing on the current frame is ended without a change of the current object of interest.

In step S608, one object of interest is determined based on the average velocity vector, from among the plurality of object-of-interest candidates. In the initial state where the object of interest has not been determined, a line is extended along the orientation of the average velocity vector, and specifies the object of interest closest to that line. In a case where a plurality of objects of interest is closest to that line, the object of interest closest to a position of an object of attention is specified. Alternatively, an initial value of the object of interest may previously be set by the user operation. In the present exemplary embodiment, change of the object of interest is determined based on the orientation and magnitude of the orthographically projected vector.

In a case where the orthographically projected vector points in the positive direction and a magnitude thereof is greater than or equal to the predetermined magnitude, and the current object of interest is not the goal 71 on the positive side of the x axis, the goal 71 is determined to be (specified as) the object of interest. In a case where the vector points in the negative direction and a magnitude thereof is greater than or equal to the predetermined magnitude, and a goal of current attention is not the goal 72 on the negative side of the x axis, the goal 72 is determined to be the object of interest.

Through the operations in steps S601 to S608 performed on each frame, the movements of all of the objects are detected to determine the object of interest. The object-of-interest determination unit 110 outputs the information about the determined object of interest to the viewpoint generation unit 109.

As described above, the viewpoint generation unit 109 arranges the virtual viewpoint in the direction with a predetermined rotation angle from a line that connects the object and the object of interest. In a case where the object of interest is changed to the goal 72 from the goal 71, the viewpoint generation unit 109 initially determines the current angle and the angle after change of the object of interest, and spends a predetermined period of time to rotate the virtual viewpoint by a difference between the angles, thus complementing the virtual viewpoint, instead of changing the virtual viewpoint instantaneously. Through the above processing, when the object of interest is changed, the viewer can correctly recognize that the object of interest which the viewer is currently paying attention to is changed.

As described above, according to the present disclosure, change of offense and defense can be detected from the movements of all of the objects participating in the sporting event, such as basketball, so that the viewpoint generation unit 109 can automatically generate the virtual viewpoint with which the goal on the offensive side can be captured in accordance with the detection. Thus, a virtual viewpoint image that follows and includes the object specified by the user can appropriately be produced depending on a scene.

In the present exemplary embodiment, components of the goal direction of the average velocity vector are calculated in step S606. However, directional components to be calculated are different depending on an image capturing target and an object-of-interest candidate. For example, in a case where the image capturing target is 100-meter dash of a track and field event, a line extending from a starting line to a finishing line is specified as the x axis direction. Thus, different directional components of the average velocity vector are calculated depending on the image capturing target and the object of interest. Therefore, for example, in a case where a combination of a plurality of object-of-interest candidates has been determined, predetermined directional components may previously be provided and stored for that combination.

In the present exemplary embodiment, components of the goal direction of the average velocity vector are calculated in step S606. However, the present exemplary embodiment is not limited thereto. The object of interest may be specified from the orientation of the average velocity vector. More specifically, a line is arranged in the orientation of the average velocity vector, and an object of interest closest to the line is specified. There is a possibility that a plurality of object-of-interest candidates is closest to that line. In this case, the object of interest closest to the position of an object of further attention is specified. Through this process, one object of interest can be specified from among the plurality of object-of-interest candidates.

### Other Embodiments of First Exemplary Embodiment

In the present exemplary embodiment, object position detection means based on a result of shape estimation has been described as the object position detection unit 114. However, the present disclosure is not limited to this object position detection method. For example, a position sensor such as a global positioning system (GPS) may be attached to a player to obtain a sensor value, or the object position may be detected from images acquired from a plurality of image capturing units using an image recognition technique.

In the present exemplary embodiment, the object-of-interest determination unit 110 calculates a velocity and a moving direction for each frame when the virtual viewpoint image is generated, but this is not restrictive. For example, the object position detection unit 114 may calculate a velocity vector of each object and store the velocity vector in the storage unit 108 while detecting a position. In this case, the object-of-interest determination unit 110 acquires a velocity vector of each object from the storage unit 108 and determines the object of interest.

In the present exemplary embodiment, averaging processing is performed as the filter processing for the position information, but this is not restrictive. For example, a low-pass filter, such as an infinite impulse response (IIR) filter or a finite impulse response (FIR) filter, may be employed. However, in a case where the low-pass filter is employed in a configuration in which the velocity is calculated each time, a value will not be calculated correctly if time to reproduce the virtual viewpoint image is changed to be discontinuous. In such a case, it is desirable that the averaging processing be executed after acquiring the nearby time information as described above.

In the present exemplary embodiment, basketball is taken as an example of the image capturing target. However, the present disclosure is also applicable to the other sporting events, such as soccer and rugby. For example, in a case where the image capturing target is soccer, development of the game is slow, and a period when all the players are relatively motionless is long as compared with basketball. In such a case, the object-of-interest determination unit 110 determines which side of the field the objects (players) are present more, and may determine the object of interest by comprehensively determining the determination result and the velocity vectors of the objects.

A second exemplary embodiment of the present disclosure will be described below. In the first exemplary embodiment, the object of interest is determined based on the average velocity vector of all of the objects, which are players. However, the object of interest may be determined based on the movement of one player. For example, when the virtual viewpoint image that follows a runner of baseball is to be generated, the object of interest may be determined with the movement of the runner being focused. In the present exemplary embodiment, baseball is taken as an example of the image capturing target. A configuration according to the present exemplary embodiment is similar to the configuration illustrated in the block diagram of FIG. 1, and constituent elements which are not described in particular are similar to those of the first exemplary embodiment, so that descriptions thereof are omitted.

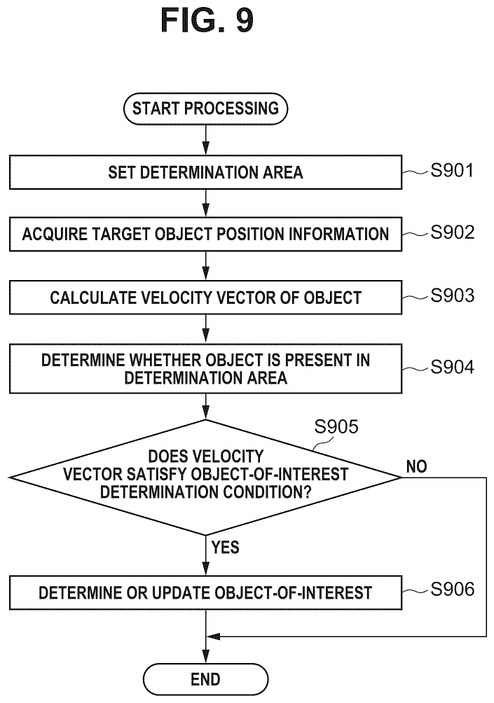

FIG. 9 is a flowchart illustrating the object-of-interest determination processing to be performed by the object-of-interest determination unit 110 according to the present exemplary embodiment. This processing is executed on each frame.

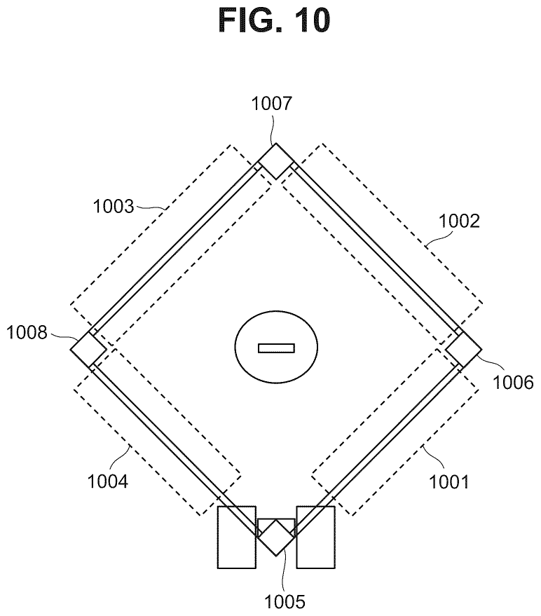

FIG. 10 is a diagram illustrating examples of object-of-interest candidates and determination areas (predetermined areas) according to the present exemplary embodiment. In the present exemplary embodiment, a home base 1005, a first base 1006, a second base 1007, and a third base 1008 are specified as the object-of-interest candidates.

In step S901, the object-of-interest determination unit 110 sets a first determination area 1001, a second determination area 1002, a third determination area 1003, and a fourth determination area 1004 based on a user operation performed on a user interface (not illustrated). At this time, object-of-interest candidates to be associated with the determination areas 1001 to 1004 are set. More specifically, the home base 1005 and the first base 1006 are associated with the first determination area 1001. Similarly, the first base 1006 and the second base 1007 are associated with the second determination area 1002, the second base 1007 and the third base 1008 are associated with the third determination area 1003, and the third base 1008 and the home base 1005 are associated with the fourth determination area 1004. The object-of-interest determination unit 110 acquires the position information about the object-of-interest candidates in association with the determination areas, and acquires a direction vector connecting the two object-of-interest candidates. For example, for the second determination area 1002, a unit direction vector that connects the first base 1006 and the second base 1007 is obtained. At this time, the unit direction vector indicates the second base 1007 direction. The position information about the determination areas and the object-of-interest candidates are managed as condition information, and may be stored in the object-of-interest determination unit 110 or the storage unit 108. The operation in step S901 is performed for only the first frame in which the object of interest is determined, instead of performing the operation for all the frames. However, the present exemplary embodiment is not limited thereto, and the operation in step S901 may be performed at an optional timing specified by the user.

In step S902, the object-of-interest determination unit 110 acquires a piece of object position information based on the time indicated by the time indication unit 111, from among pieces of object position information that the object position detection unit 114 has detected and stored in the storage unit 108.

In step S903, as in the first exemplary embodiment, a velocity vector of a target object is acquired. At this time, as in the first exemplary embodiment, filter processing is performed on the acquired object position information.

In step S904, the object-of-interest determination unit 110 determines whether the target object is present in any one of the four determination areas 1001 to 1004 set previously. The present exemplary embodiment is described with respect to a case where the target object is present in the second determination area 1002. Next, a plurality of object-of-interest candidates in association with the second determination area 1002 is specified. In the present exemplary embodiment, the first base 1006 and the second base 1007 are specified as the object-of-interest candidates.

In step S905, the object-of-interest determination unit 110 determines whether the velocity vector resulting from the calculation in step S903 satisfies the object-of-interest determination condition. As in the first exemplary embodiment, in the initial state where the object of interest has not been determined, the processing proceeds to step S906 irrespective of whether the object of interest determination condition is satisfied. The object-of-interest determination unit 110 determines an orientation and magnitude of a vector acquired by orthographically projecting the velocity vector of the object on the unit direction vector in association with the determination area. In the present exemplary embodiment, the object-of-interest determination condition is that whether the magnitude of the vector acquired through the orthogonal projection is greater than a predetermined magnitude. In a case where the magnitude of the vector acquired through the orthogonal projection is greater than a predetermined magnitude (YES in step S905), the processing proceeds to step S906. In a case where the magnitude of the vector acquired through the orthogonal projection is smaller than or equal to the predetermined magnitude (NO in step S905), the processing is ended.

In step S906, from among the plurality of object-of-interest candidates specified in step S904, one object of interest is determined based on the average velocity vector. In the initial state where the object of interest has not been determined, the processing similar to that of the first exemplary embodiment is executed. In a case where the magnitude of the vector acquired through the orthogonal projection is greater than a predetermined magnitude, and the orientation of the vector acquired through the orthogonal projection is the second base 1007 direction which is the same as the unit direction vector, the second base 1007 is determined as the object of interest. In a case where the orientation of the vector acquired through the orthogonal projection is opposite to the unit direction vector, the first base 1006 is determined to be the object of interest. The operations in steps S902 to S906 are performed for each frame, so that a virtual viewpoint that focuses an appropriate object of interest while following a movement of a player can be generated.

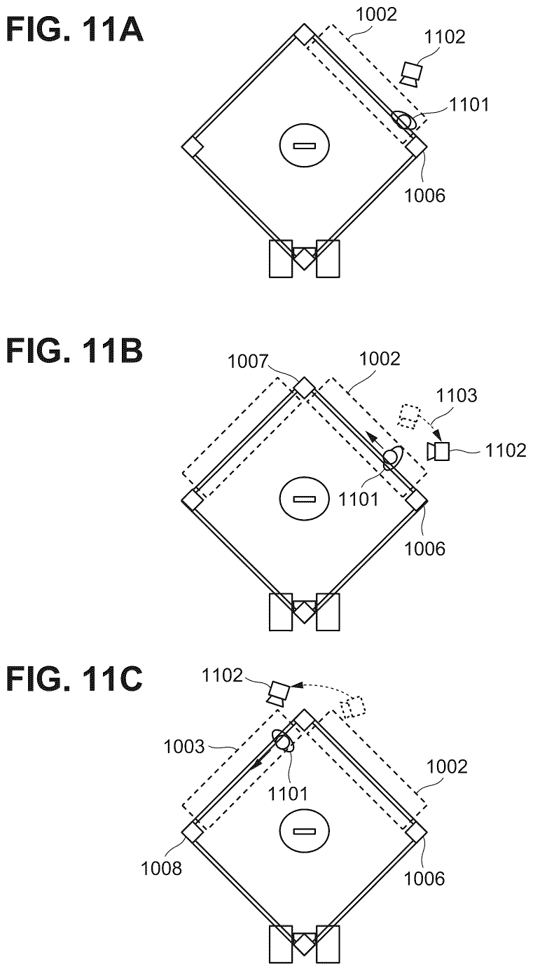

FIGS. 11A to 11C are diagrams illustrating examples of the movement of an object, object of interests, and a virtual viewpoint according to the second exemplary embodiment. The movement of a player (runner) and change of an object of interest are described with reference to FIGS. 11A to 11C. Here, a description is provided based on the assumption that a runner 1101 is present near the first base 1006 as illustrated in FIG. 11A. When the runner 1101 is present near the first base 1006, the first base 1006 is specified as the object of interest that is currently being paid attention to, because the runner 1101 reaches the first base 1006 after passing through the first determination area 1001. At this time, the runner 1101 takes a lead to enter the second determination area 1002. However, the first base 1006 is still specified as the object of interest because the runner 1101 moves at a low velocity. The virtual viewpoint generated by the viewpoint generation unit 109 at this point of time is a virtual viewpoint 1102 which captures the runner 1101 and the first base 1006 from a position diagonally behind the runner 1101 as illustrated in FIG. 11A. When the velocity reaches a predetermined velocity or greater because the runner 1101 starts running and attempts to advance to the next base, the object of interest that is being paid attention to is changed to the second base 1007. Thus, the virtual viewpoint 1102 that follows the runner 1101 is rotated around the runner 1101 as indicated by a dashed arrow 1103 in FIG. 11B, and automatically shifts to the virtual viewpoint 1102 which captures the second base 1007 over the shoulder of the runner 1101 while following the runner 1101. Further, for example, in a case where the runner 1101 who is advancing to the second base 1007 attempts to return to the first base 1006 halfway through, the object of interest to be paid attention to is changed to the first base 1006, and the virtual viewpoint 1102 is shifted to the virtual viewpoint 1102 for capturing the runner 1101 and the first base 1006.

Next, in a case where the runner 1101 advances to the second base 1007 successfully, and continuously attempts to advance to the third base 1008, the runner 1101 enters the third determination area 1003. Thus, the moving direction and the velocity are determined based on the unit direction vector defined by the second base 1007 and the third base 1008 in association with the third determination area 1003. As a result, the object of interest that is being paid attention to is changed to the third base 1008 when the runner 1101 enters the third determination area 1003, so that the virtual viewpoint 1102 is moved to a position where the virtual viewpoint 1102 captures the runner 1101 and the third base 1008 as illustrated in FIG. 11C.

Application of the present disclosure as described above enables an appropriate object of interest to be specified from a plurality of object-of-interest candidates based on the information about the position and velocity of the player. Thus, the viewpoint generation unit 109 can generate an appropriate virtual viewpoint based on the specified object of interest. This makes it possible to create camera work suitable for the situation even without any operator for operating the virtual viewpoint.

According to the present disclosure, it is possible to set a virtual viewpoint suitable for the scene.

### Other Embodiments of Second Exemplary Embodiment

As in the first exemplary embodiment, the object position detection unit 114 may employ other position detection methods, such as a method employing a GPS or an image recognition technique.

In the present exemplary embodiment, the viewpoint generation unit 109 generates a virtual viewpoint that follows the object from behind. However, the present exemplary embodiment is not limited thereto. Another method can also be employed as long as the virtual viewpoint is generated using the information about the object of attention and the object of interest to be paid attention to. For example, a virtual viewpoint may be arranged near a base specified as an object of interest, and the viewpoint generation unit 109 may create camera work in such a manner that an object as a tracking target is awaited to be included into the angle of view.

In this case, with a change of the object of interest, it is desirable that the arrangement of the virtual viewpoint be shifted to a position near another base which is newly specified as the object of interest, while the object as the tracking target is captured on the front side.

In the present exemplary embodiment, an operator is not required because the virtual viewpoint is automatically generated by the viewpoint generation unit 109. However, the present exemplary embodiment is not limited thereto. For example, a distance between the virtual viewpoint generated by the viewpoint generation unit 109 and the player, a height at which the virtual viewpoint is arranged, and an angle of view may be operated by an operator via a user interface (not illustrated). This is more desirable because the operator can control the imaging composition such as the angle of view while the viewpoint generation unit 109 plays a role in fitting the object and the object of interest into the field of view.

In the present exemplary embodiment, the present disclosure is applied to baseball. However, the present disclosure is also applicable to softball and other sporting events in which the object of interest to be included in the virtual viewpoint is changed depending on the position of the player.

In the present exemplary embodiment, while a background model is specified as an object-of-interest candidate, and a position and orientation of the virtual viewpoint is determined based on a position of the object and a barycentric position of the object of interest specified by the user, the present exemplary embodiment is not limited thereto.

For example, a three-dimensional position different from the barycentric position may be associated with the background model specified as the object-of-interest candidate. In this case, the position and orientation of the virtual viewpoint is determined based on the three-dimensional positions corresponding to the position of the object and the object of interest specified by the user. This process facilitates setting of a virtual viewpoint suitable for a scene in a case where a goal net is located at a position different from the barycentric position of the background model, such as a basket goal. The three-dimensional position corresponding to the background model may be set at a height the same as a height of the barycentric position of the object. For example, in a case where the object of interest is a base of baseball, there is a possibility that a virtual viewpoint image corresponding to the virtual viewpoint facing to a floor face is generated because the object of interest is present on the floor surface. Thus, a height of the three-dimensional position corresponding to the background model is adjusted, so that the user can easily set a virtual viewpoint suitable for a scene.

### Other Configurations

The above-described exemplary embodiments are described based on the assumption that the processing units illustrated in FIG. 1 are implemented by hardware devices. However, the processing executed by the processing units illustrated in FIG. 1 may be implemented by a computer program.

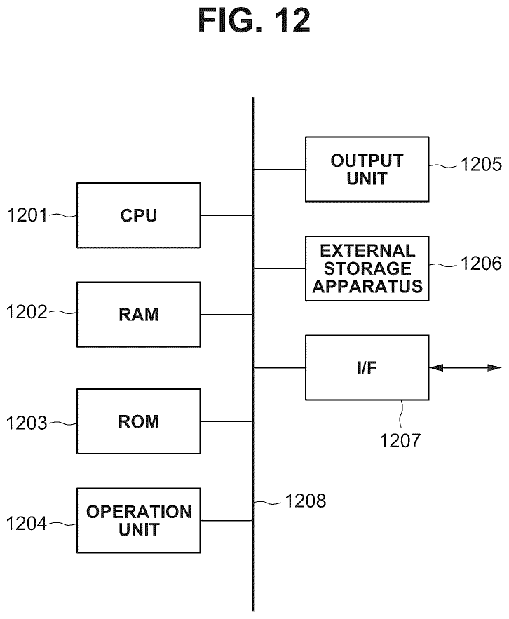

FIG. 12 is a block diagram illustrating an example of a hardware configuration of a computer applicable to an indirect position estimation apparatus according to the above-described exemplary embodiments.

A central processing unit (CPU) 1201 executes control of the entire computer using a computer program and data stored in a random access memory (RAM) 1202 and a read only memory (ROM) 1203, and executes the above-described processing as the processing executed by the indirect position estimation apparatus according to the above-described exemplary embodiments. In other words, the CPU 1201 functions as the respective processing units illustrated in FIG. 1.

The RAM 1202 includes an area for temporarily storing a computer program and data loaded from an external storage apparatus 1206 and data acquired from an external apparatus via an interface (I/F) 1207. The RAM 1202 further includes a work area to be used when the CPU 1201 executes various types of processing. In other words, for example, the RAM 1202 can allocate the area as a frame memory and can also provide other various areas as appropriate.

Setting data and a boot program of the computer are stored in the ROM 1203. An operation unit 1204 includes a keyboard and a mouse, and the user of this computer can input various instructions to the CPU 1201 by operating the operation unit 1204. An output unit 1205 displays a result of the processing executed by the CPU 1201. The output unit 1205 includes a liquid crystal display. For example, the viewpoint generation unit 109 includes the operation unit 1204, and the display unit 113 includes the output unit 1205.

The external storage apparatus 1206 is a large-capacity information storage apparatus represented by a hard disk drive apparatus. An operating system (OS) and a computer program for causing the CPU 1201 to implement functions of the respective units illustrated in FIG. 1 are saved in the external storage apparatus 1206. Further, various types of image data treated as processing targets may also be saved in the external storage apparatus 1206.

A computer program and data saved in the external storage apparatus 1206 are loaded on the RAM 1202 as appropriate according to the control executed by the CPU 1201, and treated as the processing targets of the CPU 1201. A network such as a local area network (LAN) and the internet, and other devices such as a projection device and a display device can be connected to the I/F 1207, and the computer can acquire and send various types of information via the I/F 1207. In the first exemplary embodiment, the image capturing units 101 are connected thereto, so that the computer receives images captured thereby and executes control via the I/F 1207. A bus 1208 connects respective units described above.

Functions of the above-described constituent elements are implemented by the CPU 1201 which plays a central role in controlling the functions described in the above-described exemplary embodiments.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-103415, filed Jun. 23, 2023, which is hereby incorporated by reference herein in its entirety.

What is claimed is:

1. An information processing apparatus comprising:
one or more memories storing instructions; and
one or more processors executing the instructions to;
acquire position information indicating a position of an object included in an image capturing area captured by a plurality of image capturing apparatuses;
specify one position of interest from among a plurality of positions of interest, based on a moving direction of the object; and
determine a position of a virtual viewpoint corresponding to a virtual viewpoint image related to the object and a line-of-sight direction of the virtual viewpoint, based on the specified position of interest and the position of the object.

2. The information processing apparatus according to claim 1,
wherein the position information indicates positions of a plurality of objects, and
wherein the specified position of interest is specified based on moving directions of the plurality of objects.

3. The information processing apparatus according to claim 2, wherein the specified position of interest is specified based on the moving directions of the plurality of objects and moving velocities of the plurality of objects.

4. The information processing apparatus according to claim 2,
wherein the plurality of objects is classified into a plurality of categories including a first category and a second category, and
wherein the specified position of interest is specified based on the moving directions of the plurality of objects corresponding to the first category.

5. The information processing apparatus according to claim 4,
wherein the plurality of image capturing apparatuses captures an athletic competition,
wherein the first category is a player, and
wherein the second category is a referee.

6. The information processing apparatus according to claim 1,
wherein the one or more processors further execute the instructions to acquire condition information indicating the plurality of positions of interest corresponding to a predetermined area in a three-dimensional space, and
wherein, in a case where the object is present in the predetermined area indicated by the condition information, the specified position of interest is specified from the plurality of positions of interest corresponding to the predetermined area.

7. The information processing apparatus according to claim 1, wherein the moving direction of the object is specified based on change of a position of the object at predetermined time.

8. The information processing apparatus according to claim 1, wherein the position of interest is set based on a user operation.

9. The information processing apparatus according to claim 1, wherein the position of interest is in association with a background model.

10. The information processing apparatus according to claim 9, wherein the background model is a stationary object.

11. The information processing apparatus according to claim 10, wherein the background model is specified as a basket goal.

12. The information processing apparatus according to claim 1, wherein the position of the virtual viewpoint and the line-of-sight direction of the virtual viewpoint are determined based on a half line extending from the position of the object to the position of interest.

13. The information processing apparatus according to claim 12, wherein the position of the virtual viewpoint and the line-of-sight direction of the virtual viewpoint are determined operable to an angle formed by the half line extending from the position of the object to the position of interest and the line-of-sight direction of the virtual viewpoint becomes a predetermined angle.

14. The information processing apparatus according to claim 1, wherein the position of the virtual viewpoint and the line-of-sight direction of the virtual viewpoint are determined operable to the object and the position of interest are included in the virtual viewpoint image.

15. An information processing method comprising:
acquiring position information indicating a position of an object included in an image capturing area captured by a plurality of image capturing apparatuses;
specifying one position of interest from among a plurality of positions of interest, based on a moving direction of the object; and
determining a position of a virtual viewpoint corresponding to a virtual viewpoint image related to the object and a line-of-sight direction of the virtual viewpoint, based on the specified position of interest and the position of the object.

16. A non-transitory computer-readable storage medium storing a computer program for causing a computer to execute an image processing method comprising:
acquiring position information indicating a position of an object included in an image capturing area captured by a plurality of image capturing apparatuses;
specifying one position of interest from among a plurality of positions of interest, based on a moving direction of the object; and
determining a position of a virtual viewpoint corresponding to a virtual viewpoint image related to the object and a line-of-sight direction of the virtual viewpoint, based on the specified position of interest and the position of the object.
